(19) United States
(12) Patent Application Publication
(10) Pub. No.: US 2017/0305936 A1
(43) Pub. Date: Oct. 26, 2017

(54) SOLID STATE FORMS OF CRISABOROLE

(71) Applicant: Pliva Hrvatska d.o.o., Zagreb (HR)

(72) Inventors: Helena Ceric, Zagreb (HR); Marica Malenica, Zagreb (HR); Marina Ratkaj, Zagreb (HR); Ivana Landeka, Zagreb (HR); Alexandr Jegorov, Dobra Voda (CZ)

(21) Appl. No.: 15/648,175

(22) Filed: Jul. 12, 2017

Related U.S. Application Data
(60) Provisional application No. 62/361,237, filed on Jul. 12, 2016.

(51) Int. Cl. C07F 5/02

(52) U.S. Cl. CPC C07F 5/025; C07B 2200/13

(57) ABSTRACT

Solid state forms of Crisaborole and salts thereof, processes for preparation thereof and pharmaceutical compositions thereof are disclosed.

### CROSS-REFERENCE TO RELATED APPLICATION

This application claims the benefit of U.S. Provisional Application No. 62/361,237 filed Jul. 12, 2016, which is hereby incorporated by reference in its entirety.

### FIELD OF THE INVENTION

The present disclosure relates to solid state forms of Crisaborole and salts thereof, processes for preparation thereof and pharmaceutical compositions thereof.

### BACKGROUND OF THE INVENTION

Crisaborole has the chemical name 5-(4-Cyanophenoxy)-1,3-dihydro-1-hydroxy-2,1-benzoxaborole. Crisaborole has the following chemical structure:

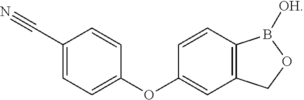 [SMILES: N#Cc1ccc(Oc2ccc3c(c2)COB3O)cc1]

Crisaborole is apparently a phosphodiesterase-4 inhibitor, indicated for topical treatment of atopic dermatitis and under investigation for psoriasis.

Crisaborole is known from U.S. Pat. No. 8,039,451.

Polymorphism, the occurrence of different crystal forms, is a property of some molecules and molecular complexes. A single compound, like Crisaborole, may give rise to a variety of polymorphs having distinct crystal structures and physical properties like melting point, thermal behaviors (e.g. measured by thermogravimetric analysis—“TGA”, or differential scanning calorimetry—“DSC”), powder X-ray diffraction (PXRD) pattern, infrared absorption fingerprint, Raman absorption fingerprint, and solid state (¹³C-) NMR spectrum. One or more of these techniques may be used to distinguish different polymorphic forms of a compound.

Different salts and solid state forms (including solvated forms) of an active pharmaceutical ingredient may possess different properties. Such variations in the properties of different salts and solid state forms and solvates may provide a basis for improving formulation, for example, by facilitating better processing or handling characteristics, improving the dissolution profile, or improving stability (polymorph as well as chemical stability) and shelf-life. These variations in the properties of different salts and solid state forms may also provide improvements to the final dosage form, for instance, if they serve to improve bioavailability. Different salts and solid state forms and solvates of an active pharmaceutical ingredient may also give rise to a variety of polymorphs or crystalline forms, which may in turn provide additional opportunities to use variations in the properties and characteristics of a solid active pharmaceutical ingredient for providing an improved product.

Discovering new salts, solid state forms and solvates of a pharmaceutical product can provide materials having desirable processing properties, such as ease of handling, ease of processing, storage stability, and ease of purification or as desirable intermediate crystal forms that facilitate conversion to other salts or polymorphic forms. New salts, polymorphic forms and solvates of a pharmaceutically useful compound can also provide an opportunity to improve the performance characteristics of a pharmaceutical product (dissolution profile, bioavailability, etc.). It enlarges the repertoire of materials that a formulation scientist has available for formulation optimization, for example by providing a product with different properties, e.g., a different crystal habit, higher crystallinity or polymorphic stability which may offer better processing or handling characteristics, improved dissolution profile, or improved shelf-life.

For at least these reasons, there is a need for solid state forms (including solvated forms) of Crisaborole and salts thereof, in particular as polymorphically pure material.

### SUMMARY OF THE INVENTION

The present disclosure relates to solid state forms of Crisaborole and salts thereof, to processes for preparation thereof, and to pharmaceutical compositions comprising these solid state forms.

The present disclosure also provides uses of the solid state forms of Crisaborole and salts thereof for preparing other solid state forms of Crisaborole, Crisaborole salts and solid state forms thereof.

In another embodiment, the present disclosure encompasses the above described solid state forms of Crisaborole and salts thereof for use in the preparation of pharmaceutical compositions and/or formulations, preferably for the treatment of psoriasis and/or atopic dermatitis.

In another embodiment the present disclosure encompasses the use of the above described solid state form of Crisaborole and salts thereof for the preparation of pharmaceutical compositions and/or formulations.

The present disclosure further provides pharmaceutical compositions comprising the solid state forms of Crisaborole and salts thereof according to the present disclosure.

In yet another embodiment, the present disclosure encompasses pharmaceutical formulations comprising the above described solid state forms of Crisaborole and salts thereof and at least one pharmaceutically acceptable excipient, preferably for topical treatment in a form of cream or ointment.

The present disclosure encompasses processes to prepare said pharmaceutical formulations of Crisaborole comprising combining the above solid state forms and at least one pharmaceutically acceptable excipient.

The solid state forms as defined herein, as well as the pharmaceutical compositions or formulations of the solid state form of Crisaborole and salts thereof, can be used as medicaments, particularly for the treatment of psoriasis and/or atopic dermatitis.

The present disclosure also provides methods of treating psoriasis and/or atopic dermatitis, comprising administering a therapeutically effective amount of the solid state form of Crisaborole and salts thereof of the present disclosure, or at least one of the above pharmaceutical compositions or formulations, to a subject suffering from psoriasis, atopic dermatitis, or otherwise in need of the treatment.

The present disclosure also provides uses of the solid state forms of Crisaborole and salts thereof of the present disclosure, or at least one of the above pharmaceutical compositions or formulations for the manufacture of a medicament for treating psoriasis and/or atopic dermatitis.

### BRIEF DESCRIPTION OF THE FIGURES

FIG. 1 shows a powder X-ray diffraction pattern (“powder XRD” or “PXRD”) of Crisaborole form I obtained in Example 1a.

FIG. 2 shows a DSC thermogram of Crisaborole form I obtained in Example 1a.

FIG. 3 shows an FTIR spectrum of Crisaborole form I obtained in Example 1a.

FIG. 4 shows a powder X-ray diffraction pattern of Crisaborole form II obtained in Example 2.

FIG. 5 shows a DSC thermogram of Crisaborole form II obtained in Example 2.

FIG. 6 shows an FTIR spectrum of Crisaborole form II obtained in Example 2.

FIG. 7 shows a powder X-ray diffraction pattern of Crisaborole form III obtained in Example 3.

FIG. 8 shows a DSC thermogram of Crisaborole form III obtained in Example 3.

FIG. 9 shows an FTIR spectrum of Crisaborole form III obtained in Example 3.

FIG. 10 shows a powder X-ray diffraction pattern of Crisaborole form IV obtained in Example 4.

FIG. 11 shows a DSC thermogram of Crisaborole form IV obtained in Example 4.

FIG. 12 shows an FTIR spectrum of Crisaborole form IV obtained in Example 4.

FIG. 13 shows a powder X-ray diffraction pattern of Crisaborole amorphous obtained in Example 5.

FIG. 14 shows an ssNMR spectrum of Crisaborole form I.

FIG. 15 shows a Raman spectrum of Crisaborole form I.

FIG. 16 shows an ssNMR spectrum of Crisaborole form II.

FIG. 17 shows a Raman spectrum of Crisaborole form II.

### DETAILED DESCRIPTION OF THE INVENTION

The present disclosure relates to solid state forms of Crisaborole (crystalline and amorphous forms) and salts thereof, processes for preparation thereof and pharmaceutical compositions comprising said solid state forms.

The solid state forms of Crisaborole according to the present disclosure may have advantageous properties selected from at least one of: chemical or polymorphic purity, flowability, solubility, dissolution rate, bioavailability, morphology or crystal habit, stability—such as chemical stability as well as thermal and mechanical stability with respect to polymorphic conversion, stability towards dehydration and/or storage stability, a lower degree of hygroscopicity, low content of residual solvents and advantageous processing and handling characteristics such as compressibility, or bulk density.

A crystal form may be referred to herein as being characterized by graphical data “as depicted in” a Figure. Such data include, for example, powder X-ray diffractograms and solid state NMR spectra. As is well-known in the art, the graphical data potentially provides additional technical information to further define the respective solid state form (a so-called “fingerprint”) which can not necessarily be described by reference to numerical values or peak positions alone. In any event, the skilled person will understand that such graphical representations of data may be subject to small variations, e.g., in peak relative intensities and peak positions due to factors such as variations in instrument response and variations in sample concentration and purity, which are well known to the skilled person. Nonetheless, the skilled person would readily be capable of comparing the graphical data in the Figures herein with graphical data generated for an unknown crystal form and confirm whether the two sets of graphical data are characterizing the same crystal form or two different crystal forms. A crystal form of Crisaborole and salts thereof referred to herein as being characterized by graphical data “as depicted in” a Figure will thus be understood to include any crystal forms of the Crisaborole and salts thereof, characterized with the graphical data having such small variations, as are well known to the skilled person, in comparison with the Figure.

A solid state form (or polymorph) may be referred to herein as polymorphically pure or substantially free of any other solid state (or polymorphic) forms. As used herein in this context, the expression “substantially free of any other forms” will be understood to mean that the solid state form contains about 20% or less, about 10% or less, about 5% or less, about 2% or less, about 1% or less, or about 0% of any other forms of the subject compound as measured, for example, by PXRD. Thus, solid state of Crisaborole and Crisaborole salts, described herein as substantially free of any other solid state forms would be understood to contain greater than about 80% (w/w), greater than about 90% (w/w), greater than about 95% (w/w), greater than about 98% (w/w), greater than about 99% (w/w), or about 0% (w/w) of the subject solid state form of Crisaborole and Crisaborole salts. Accordingly, in some embodiments of the disclosure, the described solid state forms of Crisaborole and Crisaborole salts may contain from about 1% to about 20% (w/w), from about 5% to about 20% (w/w), or from about 5% to about 10% (w/w) of one or more other solid state forms of the same Crisaborole and Crisaborole salts.

The modifier “about” should be considered as disclosing the range defined by the absolute values of the two endpoints. For example, the expression “from about 2 to about 4” also discloses the range “from 2 to 4.” When used to modify a single number, the term “about” may refer to plus or minus 10% of the indicated number and includes the indicated number. For example, “about 10%” may indicate a range of 9% to 11%, and “about 1” means from 0.9-1.1.

As used herein, unless stated otherwise, PXRD peaks reported herein are preferably measured using CuK_{α} radiation, λ=1.5418 Å.

As used herein, unless stated otherwise, DSC data is obtained at a heating rate of 10° C./min.

As used herein, the term “isolated” in reference to solid state forms of Crisaborole and Crisaborole salts, of the present disclosure corresponds to solid state forms of Crisaborole and Crisaborole salts that are physically separated from the reaction mixture in which it is formed.

A thing, e.g., a reaction mixture, may be characterized herein as being at, or allowed to come to “room temperature”, often abbreviated “RT.” This means that the temperature of the thing is close to, or the same as, that of the space, e.g., the room or fume hood, in which the thing is located. Typically, room temperature is from about 20° C. to about 30° C., or about 22° C. to about 27° C., or about 25° C. A process or step may be referred to herein as being carried out “overnight.” This refers to a time interval, e.g., for the process or step, that spans the time during the night, when that process or step may not be actively observed. This time interval is from about 8 to about 20 hours, or about 10 to about 18 hours, typically about 16 hours.

As used herein, the expression “wet crystalline form” refers to a polymorph that was not dried using any conventional techniques to remove residual solvent. Examples for such conventional techniques can be, but not limited to, evaporation, vacuum drying, oven drying, drying under nitrogen flow, etc.

As used herein, the expression “dry crystalline form” refers to a polymorph that was dried using any conventional techniques to remove residual solvent. Examples of such conventional techniques can be, but are not limited to, evaporation, vacuum drying, oven drying, drying under nitrogen flow, etc.

As used herein the term non-hygroscopic in relation to crystalline Crisaborole refers to less than 0.2% (w/w) of water absorption after 24 h exposure to 25° C./80% RH, determined according to European Pharmacopoeia 7.0, chapter 01/2008:51100. Water can be for example atmospheric water.

The term “solvate”, as used herein and unless indicated otherwise, refers to a crystal form that incorporates a solvent in the crystal structure. When the solvent is water, the solvate is often referred to as a “hydrate.” The solvent in a solvate may be present in either a stoichiometric or in a non-stoichiometric amount.

The amount of solvent employed in a chemical process, e.g., a reaction or a crystallization, may be referred to herein as a number of “volumes” or “vol” or “V.” For example, a material may be referred to as being suspended in 10 volumes (or 10 vol or 10V) of a solvent. In this context, this expression would be understood to mean milliliters of the solvent per gram of the material being suspended, such that suspending 5 grams of a material in 10 volumes of a solvent means that the solvent is used in an amount of 10 milliliters of the solvent per gram of the material that is being suspended or, in this example, 50 mL of the solvent. In another context, the term “v/v” may be used to indicate the number of volumes of a solvent that are added to a liquid mixture based on the volume of that mixture. For example, adding MTBE (1.5 v/v) to a 100 ml reaction mixture would indicate that 150 mL of MTBE was added.

As used herein, the term “reduced pressure” refers to a pressure of about 10 mbar to about 50 mbar.

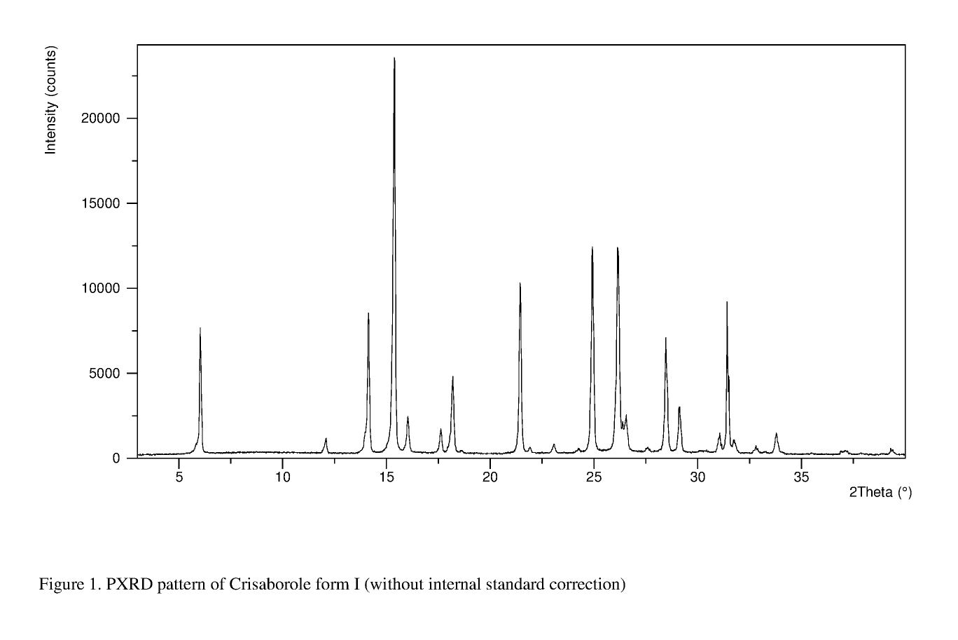

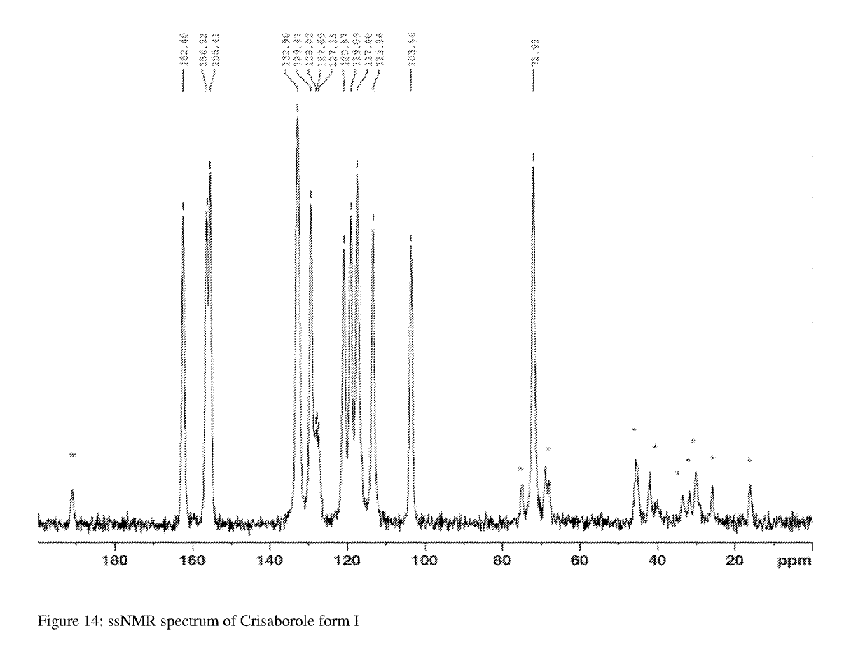

The present disclosure comprises a crystalline form of Crisaborole designated as form I. The crystalline form I of Crisaborole can be characterized by data selected from one or more of the following: a PXRD pattern having peaks at 6.0, 14.1, 15.4, 16.1 and 28.5 degrees 2-theta±0.2 degrees 2-theta; a PXRD pattern as depicted in FIG. 1 and combinations of these data. Crystalline form I of Crisaborole may alternatively or additionally be characterized by data selected from one or more of the following: a solid state ¹³C NMR spectrum with peaks at 162.4, 155.4, 129.4, 120.9, 119.1 ppm±0.2 ppm; or by a solid state ¹³C NMR spectrum having the following chemical shift absolute differences from a peak at 117.4 ppm±1 ppm of 45.0, 38.0, 12.0, 3.5 and 1.7 ppm±0.1 ppm; or by a solid state ¹³C NMR spectrum substantially as depicted in FIG. 14; or combinations of these data.

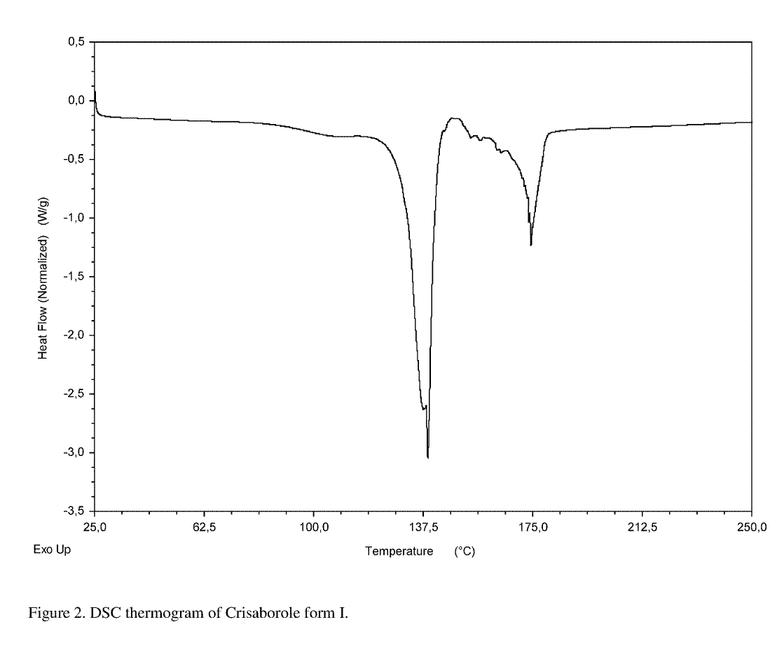

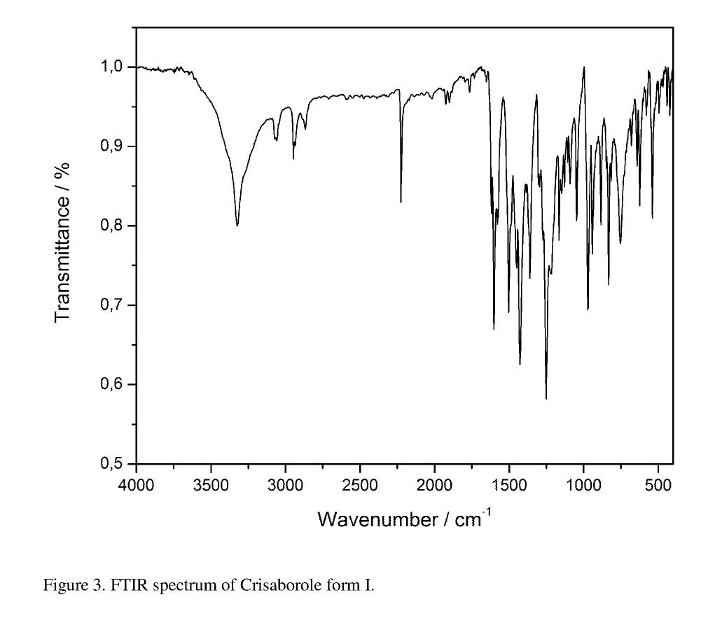

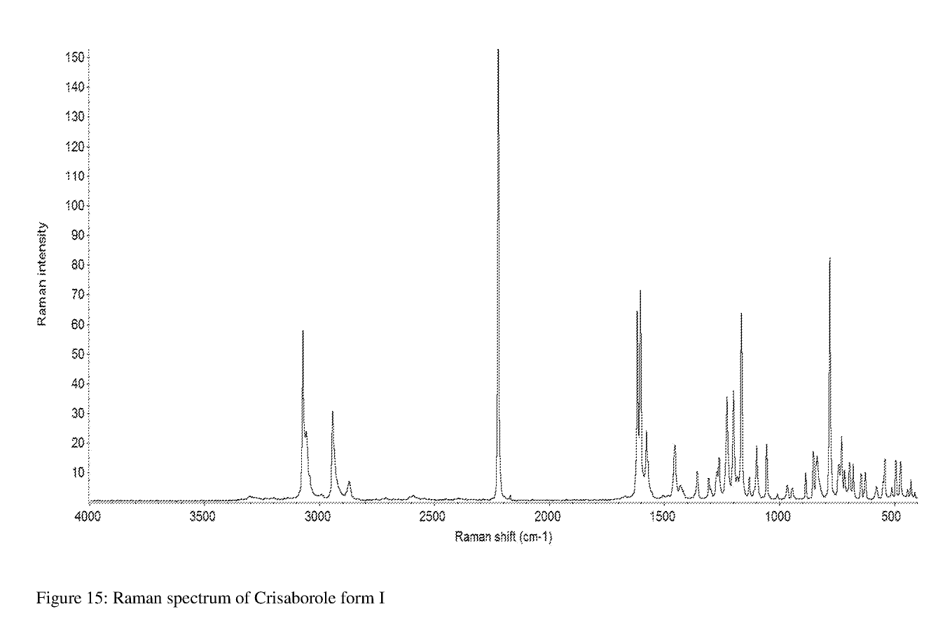

Crystalline form I of Crisaborole may be further characterized by the PXRD pattern having peaks at 6.0, 14.1, 15.4, 16.1 and 28.5 degrees 2-theta±0.2 degrees 2-theta, and also having one, two, three, four or five additional peaks at 12.1, 18.2, 21.4, 24.9 and 26.1 degrees 2-theta±0.2 degrees 2-theta; a DSC thermogram as depicted in FIG. 2; an FTIR spectrum having one, two, three or four peaks selected from 2225, 1164, 884 and 753±4 cm⁻¹; an FTIR spectrum as depicted in FIG. 3, and combinations of these data. Crystalline form I of Crisaborole may alternatively or additionally be characterized by data selected from: a Raman spectrum having peaks at 1605, 1454, 1228, 1165 and 780±4 cm⁻¹; Raman spectrum as depicted in FIG. 15; and combinations of these data.

Crystalline form I of Crisaborole may be characterized by each of the above characteristics alone/or by all possible combinations, e.g., by PXRD pattern having peaks at 6.0, 14.1, 15.4, 16.1 and 28.5 degrees 2-theta±0.2 degrees 2-theta and an FTIR spectrum as depicted in FIG. 3.

Crystalline form I of Crisaborole may alternatively or additionally be characterized by a PXRD pattern having peaks at: 6.0, 12.1, 14.1, 15.4, 16.1, 17.6, 18.2, 18.6, 21.4, 21.9, 23.1, 24.3, 24.9, 26.1, 26.5, 27.6, 28.5, 29.1, 31.1, 31.4, 31.5, 31.7, 32.8, 33.8, 35.4, 36.9, 37.2, 37.8 and 39.3 degrees 2-theta±0.2 degrees 2-theta.

Crystalline form I of Crisaborole may be polymorphically pure.

Crystalline form I of Crisaborole according to any of the above embodiments is non-hygroscopic.

Crisaborole form I is freely soluble in propylene glycol, isopropanol and ethanol and very soluble in N,N-dimethylformamide.

Crystalline form I of Crisaborole according to any of the above embodiments is thermodynamically stable. Thermodynamic stability in relation to crystalline Crisaborole form I refers to less than 20%, 10%, 5%, 2%, 1%, or 0.5% conversion of crystalline Crisaborole form Ito any other solid state form of Crisaborole after exposure of form Ito conditions of up to 50° C./80% RH, e.g. 2-8° C., 25° C./60% RH, 40° C./75% RH for at least 1 month, as measured by XRPD. In some embodiments, the conversion is 1%-20%, 1%-10% or 1%-5%.

As discussed above, crystalline form I of Crisaborole has some advantages. For example, Crisaborole Form I exhibits good thermodynamic stability. Pharmaceutical molecules may display solid to solid phase transformations, transformations between polymorphs or between unsolvated and solvated form, which may be detected by exposure of the solid state form to stress conditions of e.g. high temperature and high RH. Crisaborole form I has shown to be non-hygroscopic, thermodynamically and chemically stable.

In addition, Form I is resistant to mechanical stress (e.g. pressure of 9 t applied on 132.67 mm² for 2 min, strong grinding in mortar with pestle for 2 min, and strong grinding with a drop of solvent in mortar with pestle for 2 min).

Moreover, Form I is stable at high humidity levels (e.g. room temperature at 100% RH for 5-7 days), including after milling procedure (e.g. feeding pressure: 6.5 bar; grinding pressure: 6 bar; rotation speed: 300 rpm).

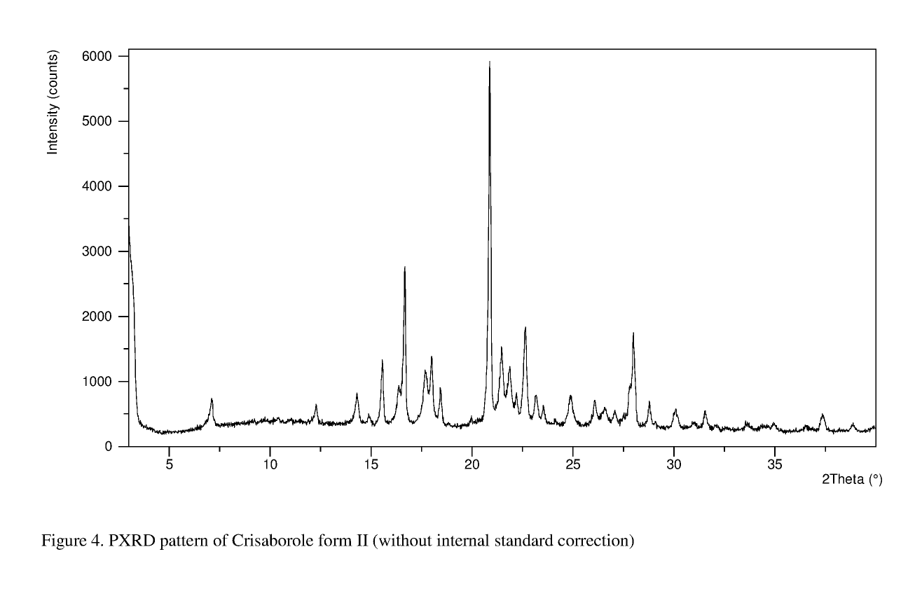

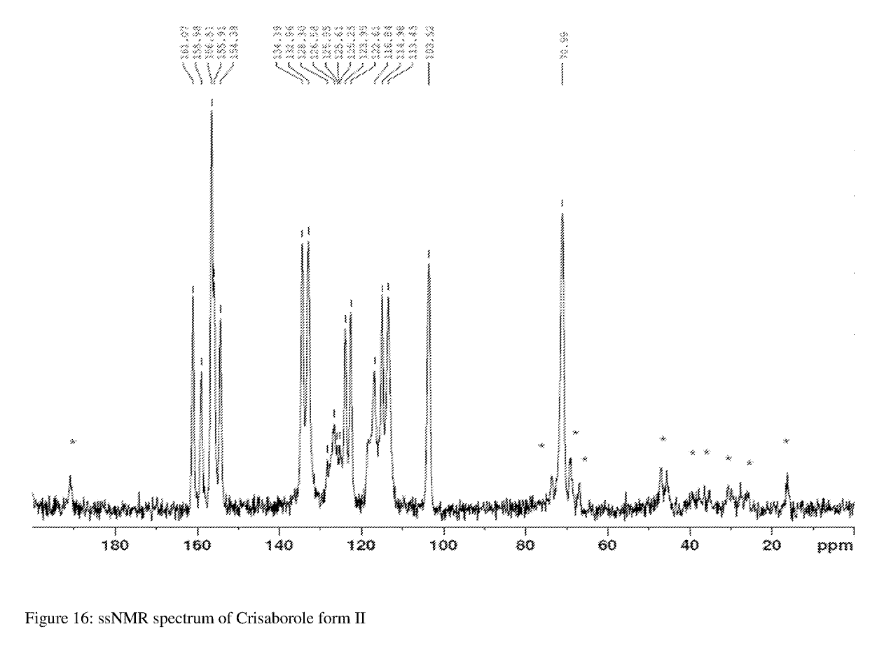

The present disclosure comprises a crystalline form of Crisaborole designated as form II. The crystalline form II of Crisaborole can be characterized by data selected from one or more of the following: a PXRD pattern having peaks at 7.1, 12.3, 16.7, 21.9 and 23.2 degrees 2-theta±0.2 degrees 2-theta; a PXRD pattern as depicted in FIG. 4 and combinations of these data. Crystalline form II of Crisaborole may alternatively or additionally be characterized by data selected from one or more of the following: a solid state ¹³C NMR spectrum with peaks at 161.1, 154.4, 134.4, 124.0 and 122.6 ppm±0.2 ppm; or by a solid state ¹³C NMR spectrum having the following chemical shift absolute differences from a peak at 115.0±1 ppm of: 46.1, 39.4, 19.4, 9.0 and 7.6 ppm±0.1 ppm; or by a solid state ¹³C NMR spectrum substantially as depicted in FIG. 16; or combinations of these data.

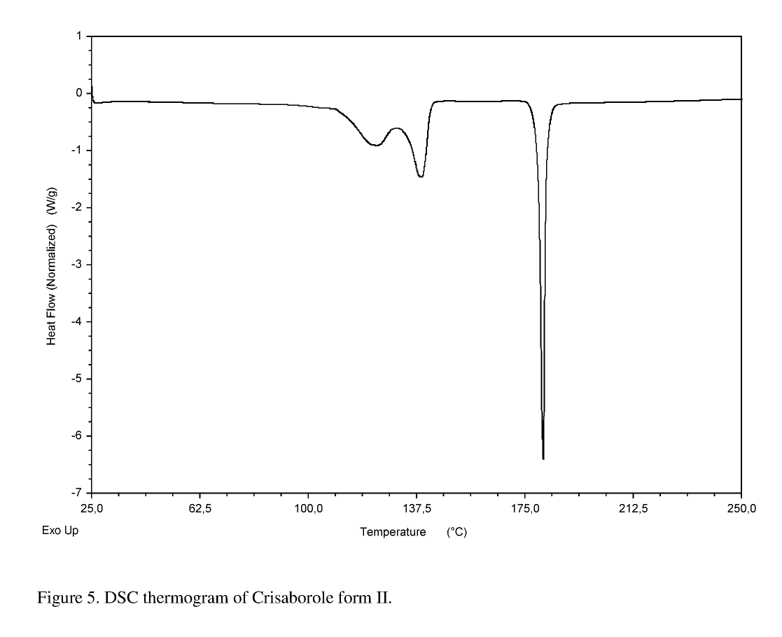

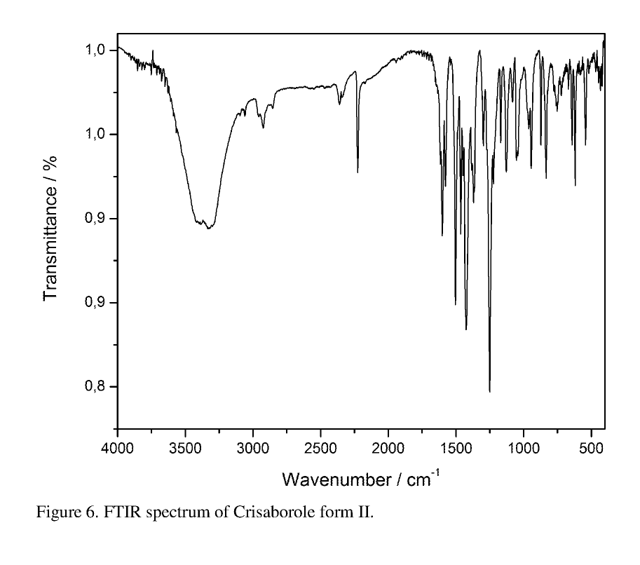

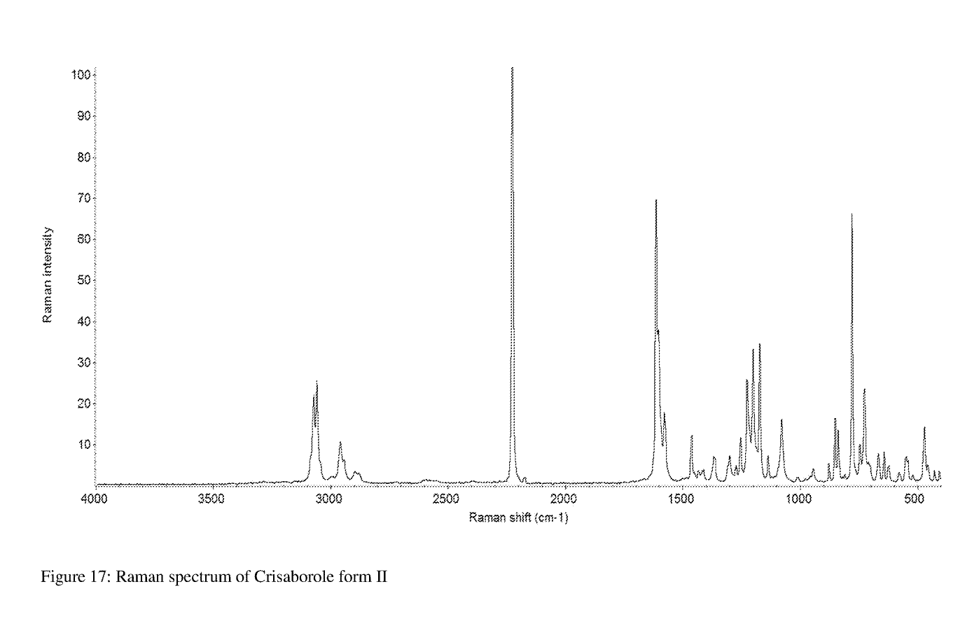

Crystalline form II of Crisaborole may be further characterized by the PXRD pattern having peaks at 7.1, 12.3, 16.7, 21.9 and 23.2 degrees 2-theta±0.2 degrees 2-theta, and also having one, two, three, four or five additional peaks at 14.3, 16.4, 20.9, 21.5 and 22.6 degrees 2-theta±0.2 degrees 2-theta; a DSC thermogram as depicted in FIG. 5; an FTIR spectrum having one, two, three or four peaks selected from 2225, 1370, 1053 and 620±4 cm⁻¹; an FTIR spectrum as depicted in FIG. 6, and combinations of these data. Crystalline form II of Crisaborole may alternatively or additionally be characterized by data selected from one or more of the following: a Raman spectrum having peaks at 1614, 1579, 1201, 1078 and 726±4 cm⁻¹; a Raman spectrum as depicted in FIG. 17; and combinations of these data.

Crystalline form II of Crisaborole may be characterized by each of the above characteristics alone/or by all possible combinations, e.g., by PXRD pattern having peaks at 7.1, 12.3, 16.7, 21.9 and 23.2 degrees 2-theta±0.2 degrees 2-theta and an FTIR spectrum as depicted in FIG. 6.

Crystalline form II of Crisaborole may alternatively or additionally be characterized by a PXRD pattern having peaks at: 7.1, 12.3, 14.3, 14.9, 15.6, 16.4, 16.7, 17.7, 18.0, 18.4, 20.0, 20.9, 21.5, 21.9, 22.2, 22.6, 23.2, 23.5, 24.1, 24.9, 26.1, 26.6, 27.1, 27.5, 27.8, 28.0, 28.8, 29.1, 30.0, 30.9, 31.5, 33.6, 35.0, 36.5, 37.3 and 38.8 degrees 2-theta±0.2 degrees 2-theta.

Crystalline form II of Crisaborole may be polymorphically pure.

Crystalline form II of Crisaborole according to any of the above embodiments is non-hygroscopic.

Crystalline form II of Crisaborole according to any of the above embodiments is thermodynamically stable. Thermodynamic stability in relation to crystalline Crisaborole form II refers to less than 20%, 10%, 5%, 2%, 1%, or 0.5% conversion of crystalline Crisaborole form II to any other solid state form of Crisaborole after exposure of form II to conditions of up to 50° C./80% RH, e.g. 25° C./60% RH, 40° C./75% RH for at least 2 months, as measured by XRPD. In some embodiments, the conversion is 1%-20%, 1%-10% or 1%-5%.

As discussed above, crystalline form II of Crisaborole has some advantages. For example, Crisaborole Form II exhibits good thermodynamic stability. Pharmaceutical molecules may display solid to solid phase transformations, transformations between polymorphs or between unsolvated and solvated form, which may be detected by exposure of the solid state form to stress conditions of e.g. high temperature and high RH. Crisaborole Form II is further stable to polymorphic conversions under high humidity.

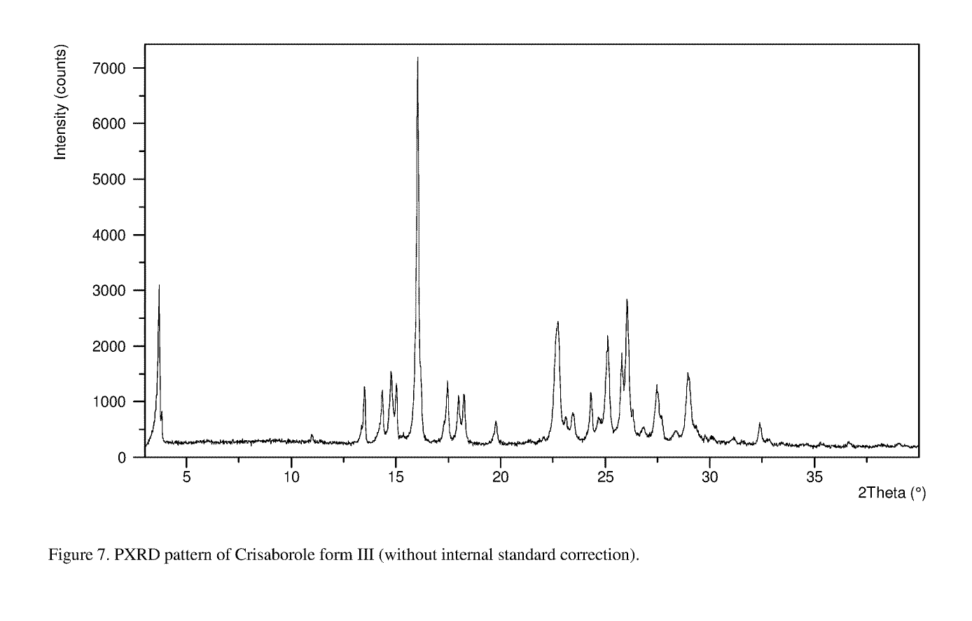

The present disclosure comprises a crystalline form of Crisaborole designated as form III. The crystalline form III of Crisaborole can be characterized by data selected from one or more of the following: a PXRD pattern having peaks at 3.7, 14.8, 16.1, 18.0 and 29.0 degrees 2-theta±0.2 degrees 2-theta; a PXRD pattern as depicted in FIG. 7; or combinations of these data.

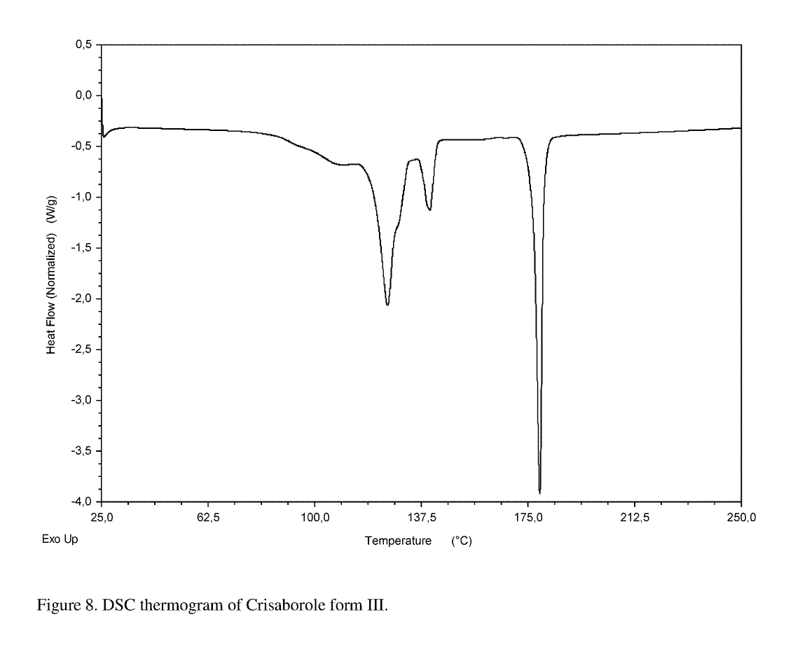

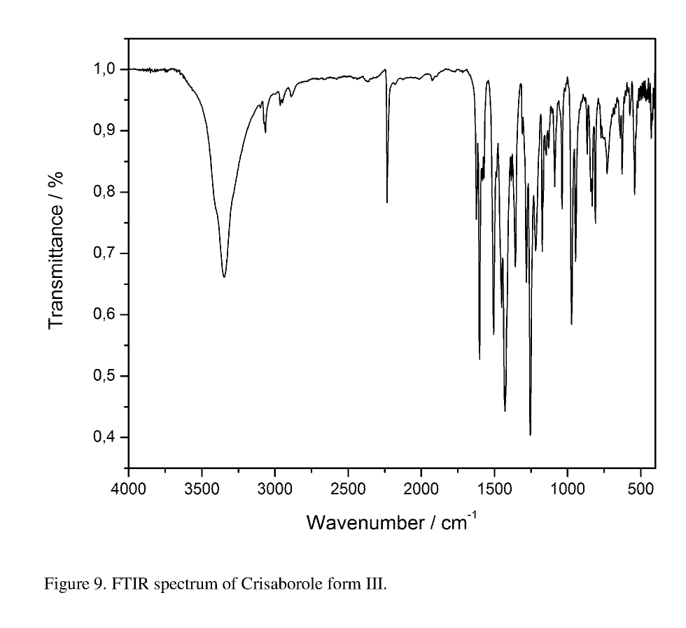

Crystalline form III of Crisaborole may be further characterized by the PXRD pattern having peaks at 3.7, 14.8, 16.1, 18.0 and 29.0 degrees 2-theta±0.2 degrees 2-theta, and also having one, two, three, four or five additional peaks at 14.4, 22.8, 25.1, 26.1 and 27.5 degrees 2-theta±0.2 degrees 2-theta; a DSC thermogram as depicted in FIG. 8; an FTIR spectrum having one, two, three, four or five peaks selected from 2233, 1624, 1282, 972 and 729±4 cm⁻¹; an FTIR spectrum as depicted in FIG. 9; and combinations of these data.

Crystalline form III of Crisaborole may be characterized by each of the above characteristics alone/or by all possible combinations, e.g., by PXRD pattern having peaks at 3.7, 14.8, 16.1, 18.0 and 29.0 degrees 2-theta±0.2 degrees 2-theta and an FTIR spectrum as depicted in FIG. 9.

Crystalline form III of Crisaborole may alternatively or additionally be characterized by a PXRD pattern having peaks at: 3.7, 11.0, 13.5, 14.4, 14.8, 15.0, 16.01, 17.5, 18.0, 18.3, 19.8, 22.6, 22.8, 23.1, 23.5, 24.3, 24.7, 25.1, 25.8, 26.01, 26.3, 26.8, 27.5, 28.4, 289.90, 29.8, 31.1, and 32.4, 32.8, 34.7, 35.3, 36.6, 38.2 and 39.0 degrees 2-theta±0.2 degrees 2-theta.

Crystalline form III of Crisaborole may be polymorphically pure.

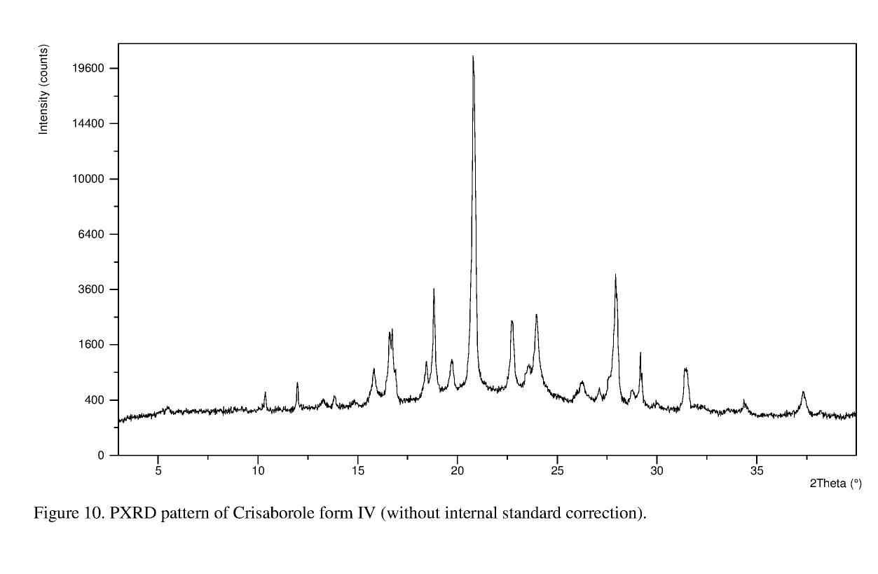

The present disclosure comprises a crystalline form of Crisaborole designated as form IV. The crystalline form IV of Crisaborole can be characterized by data selected from one or more of the following: a PXRD pattern having peaks at 5.5, 13.2, 15.7, 18.8 and 19.7 degrees 2-theta±0.2 degrees 2-theta; a PXRD pattern as depicted in FIG. 10; or combinations of these data.

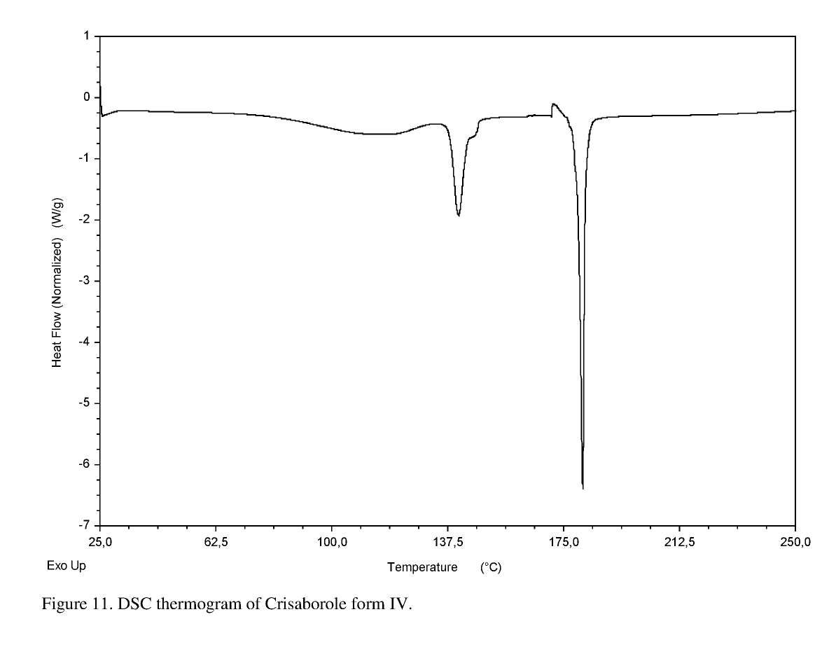

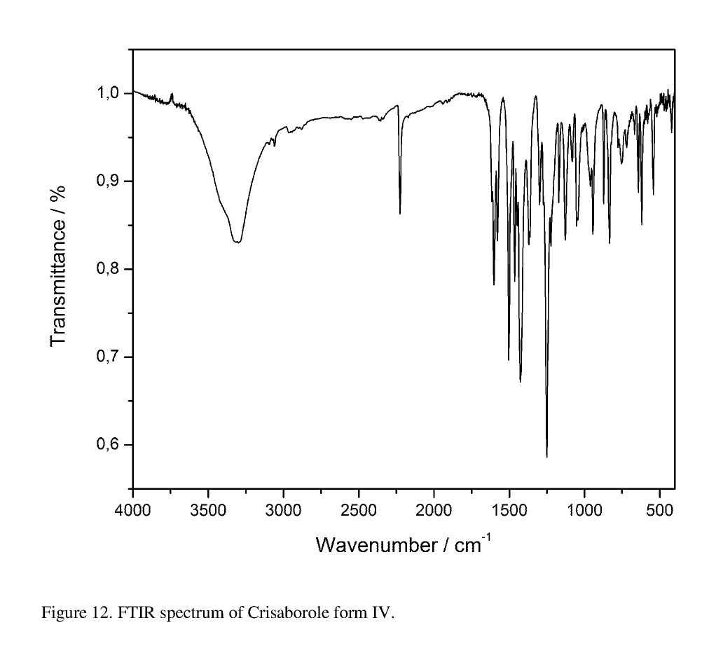

Crystalline form IV of Crisaborole may be further characterized by the PXRD pattern having peaks at 5.5, 13.2, 15.7, 18.8 and 19.7 degrees 2-theta±0.2 degrees 2-theta, and also having one, two, three, four or five additional peaks at 11.9, 16.6, 22.9, 23.9 and 24.5 degrees 2-theta±0.2 degrees 2-theta; a DSC thermogram as depicted in FIG. 11; an FTIR spectrum having one, two, three or four peaks selected from 2225, 1464, 1128 and 873±4 cm⁻¹; an FTIR spectrum as depicted in FIG. 12; and combinations of these data.

Crystalline form IV of Crisaborole may alternatively or additionally be characterized by a PXRD pattern having peaks at: 5.5, 9.2, 10.3, 11.1, 11.3, 11.9, 13.2, 13.8, 14.8, 15.7, 15.9, 16.6, 16.9, 18.4, 18.8, 19.7, 20.7, 21.3, 22.2, 22.4, 22.7, 22.9, 23.4, 23.9, 24.2, 24.5, 25.9, 26.2, 26.6, 27.1, 27.5, 27.8, 28.6, 28.7, 28.9, 29.1, 29.4, 29.8, 30.1, 30.6, 31.3, 31.8, 32.2, 32.3, 32.6, 32.8, 33.2, 33.5, 33.8, 34.2, 34.6, 35.5, 36.6, 37.3, 37.7, 38.2, 38.8 and 39.5 degrees 2-theta±0.2 degrees 2-theta.

Crystalline form IV of Crisaborole may be alternatively or additionally characterized by the following unit cell parameters: a=8.0287(6) Å, b=9.8654(8) Å, c=16.2632(12) Å, α=84.067(6°), β=81.453(6°), γ=78.537(6°), Volume 1244.81(16) Å³. Preferably, the crystalline form IV of Crisaborole has a triclinic crystal system, and/or has space group P-1.

Crystalline form IV of Crisaborole may be characterized by each of the above characteristics alone/or by all possible combinations, e.g., by PXRD pattern having peaks at 5.5, 13.2, 15.7, 18.8 and 19.7 degrees 2-theta±0.2 degrees 2-theta and an FTIR spectrum as depicted in FIG. 12.

Crystalline form IV of Crisaborole may be polymorphically pure.

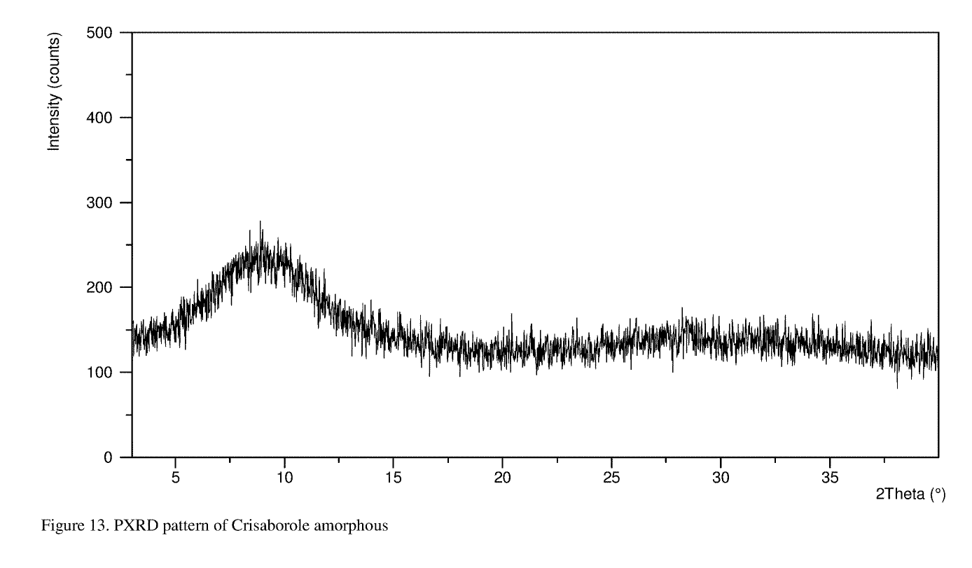

The present disclosure comprises an amorphous form of Crisaborole. Crisaborole amorphous may be characterized by a PXRD pattern as depicted in FIG. 13.

The present disclosure also provides the use of the solid state forms of Crisaborole base and Crisaborole salts, for preparing other solid state forms of Crisaborole, Crisaborole salts and solid state forms thereof.

The present disclosure further encompasses processes for preparing Crisaborole salts or solid state forms thereof. The process comprises preparing the solid state form of the present disclosure, and converting it to other solid state form of Crisaborole. Alternatively, the process comprises preparing the solid state form of the present disclosure, and converting it to Crisaborole salt. The conversion can be done, for example, by a process comprising reacting the obtained Crisaborole with an appropriate acid to obtain the corresponding acid addition.

In another embodiment the present disclosure encompasses the above described solid state forms of Crisaborole and salts thereof, for use in the preparation of pharmaceutical compositions and/or formulations, preferably for the treatment of psoriasis and atopic dermatitis.

In another embodiment the present disclosure encompasses the use of the above described solid state forms of Crisaborole and salts thereof, or combinations thereof, for the preparation of pharmaceutical compositions and/or formulations, preferably topical formulations, e.g. cream or ointment.

The present disclosure further provides pharmaceutical compositions comprising the solid state forms of Crisaborole and salts thereof, or combinations thereof, according to the present disclosure.

In yet another embodiment, the present disclosure encompasses pharmaceutical formulations comprising at least one of the above described solid state forms of Crisaborole and salts thereof, and at least one pharmaceutically acceptable excipient.

The present disclosure encompasses a process to prepare said formulations of Crisaborole comprising combining at least one of the above solid state forms and at least one pharmaceutically acceptable excipient.

The solid state forms as defined herein, as well as the pharmaceutical compositions or formulations of Crisaborole can be used as medicaments, particularly for the treatment of psoriasis and atopic dermatitis.

The present disclosure also provides a method of treating psoriasis and atopic dermatitis, comprising administering a therapeutically effective amount of the solid state form of Crisaborole of the present disclosure, or at least one of the above pharmaceutical compositions or formulations, to a subject suffering from psoriasis, atopic dermatitis or otherwise in need of the treatment.

The present disclosure also provides the use of the solid state forms of Crisaborole of the present disclosure, or at least one of the above pharmaceutical compositions or formulations for the manufacture of a medicament for treating psoriasis and atopic dermatitis.

Having described the invention with reference to certain preferred embodiments, other embodiments will become apparent to one skilled in the art from consideration of the specification. The invention is further illustrated by reference to the following examples describing in detail the preparation of the composition and methods of use of the invention. It will be apparent to those skilled in the art that many modifications, both to materials and methods, may be practiced without departing from the scope of the invention.

### Analytical Methods

### Powder X-Ray Diffraction Pattern (“PXRD”) Method:

Sample after being powdered in a mortar and pestle is applied directly on a silicon plate holder. The X-ray powder diffraction pattern was measured with Philips X'Pert PRO X-ray powder diffractometer, equipped with Cu irradiation source=1.54184 \acute{Å} (Angstrom), X'Celerator (2.022° 2θ) detector. Scanning parameters: angle range: 3-40 deg., step size 0.0167, time per step 37 s, continuous scan.

The described peak positions were determined using silicon powder as an internal standard in an admixture with the sample measured. The position of the silicon (Si) peak was corrected to silicon theoretical peak: 28.45 degrees two theta, and the positions of the measured peaks were corrected respectively.

### DSC Method:

DSC analysis was performed on Discovery DSC (TA instruments) with heating rate of 10° C./min, under nitrogen flow of 50 ml/min. A hermetic aluminium, closed pan with hole was used, and the sample mass was about 1-5 mg.

### FTIR Method:

FTIR spectrum was recorded on a Nicolet 6700 interferometer between 4000 cm⁻¹ and 370 cm⁻¹ with resolution of 4 cm⁻¹, in KBr technique.

### Solid State NMR

Solid-state ¹³C NMR spectra were recorded with variable amplitude cross polarization, magic angle spinning and high power proton decoupling using a BRUKER Avance II+spectrometer operating at 125 MHz and ambient temperature (about 25° C.—not controlled). A probe using 4 mm o.d. zirconia rotors was employed. The operation conditions were: contact time: 2 ms; recycle delay: 2 s 1024 scans; spin rate of 11 kHz. Chemical shifts were referenced via a replacement sample of glycine (carboxyl carbon chemical shift assigned as 176.03 ppm relative to the signal of tetramethylsilane).

### FT-Raman Spectroscopy

Raman spectra were acquired on a Nicolet 6700 interferometer, equipped with an NXR FT-Raman modul. Nd-YAG laser (1064 nm, 500 mW) was used to excite the sample. The spectrometer utilizes a CaF2 beamsplitter and a liquid nitrogen cooled Ge detector. The spectra were recorded at resolution of 4 cm-1.

### HPLC

HPLC analysis was performed on instrument Agilent 1290, with experimental conditions being set as follows:

### Column & Packing Acquity UPLC BEH C18, 2.1×100 mm, 1.7 μm

Buffer 10 mM KH2PO4 pH=3.0
Mobile phase A: Buffer
B: ACN

Gradient

| Time | | | Flow |
|---|---|---|---|
| [min] | % Eluent A | % Eluent B | [mL/min] |
| 0 | 90 | 5 | 0.4 |
| 30 | 10 | 90 | 0.4 |
| 30.01 | 90 | 5 | 0.4 |
| 33 | 90 | 5 | 0.4 |

Run time 33 min
Injection volume 5 μL

### Detector 252 (BW 4 nm)

Column temperature 40° C.

### EXAMPLES

The starting material Crisaborole crude may be obtained according to reference example 1 and 2:

### Reference Example 1

4-(3-Formyl-4-(4,4,5,5-tetramethyl-1,3,2-dioxaborolan-2-yl)phenoxy)benzonitrile (1.7 g, 4.87 mmol) was dissolved in ethanol (15 mL) at room temperature (RT). Mixture was cooled in an ice bath and sodium borohydride (0.2 g, 5.2 mmol) was added with vigorous stirring. Ice bath was removed after 20 minutes and mixture was stirred at RT for further two hours. Reaction was cooled in an ice bath and 6N HCl (4 mL) was added. Mixture was stirred overnight at RT and then water (100 mL) was added. Crude mixture was extracted with ethyl acetate (2×50 mL), organic layers were combined and the solvent evaporated. Residue was dissolved in ethanol (10 mL) and water (5 mL) was slowly added. The mixture was stirred for 1 h and then sonicated. The product was filtered and washed with water, yielding 350 mg of Crisaborole crude A.

### Reference Example 2

Crisaborole crude A (obtained according to reference example 1) was dissolved in tetrahydrofuran (100 volumes) at RT, the obtained solution was filtered and the solvent removed by evaporation at 40° C./20 mbar to obtain Crisaborole crude B.

### Example 1a: Preparation of Crisaborole Form I

Crisaborole crude A (15 mg) was dissolved in tetrahydrofuran (0.15 mL) at RT. The solution was left standing at RT to crystallize. The precipitate was filtered to obtain Crisaborole form I. Crisaborole form I has been confirmed by PXRD as presented in FIG. 1.

### Example 1b: Preparation of Crisaborole Form I

Crisaborole crude B (150 mg) was dissolved in methyl ethyl ketone (0.5 mL) under heating. The solution was left standing at RT to crystallize. Crisaborole form I has been confirmed by PXRD.

### Example 1c: Preparation of Benzonitrile, 4-[4-(4,4,5,5-tetramethyl-1,3,2-dioxaborolan-2-yl)-3-formylphenoxy]

Benzonitrile, 4-[4-bromo-3-(1,3-dioxolan-2-yl)phenoxy] (15 g, 43.33 mmol) was dissolved in MeTHF (75 mL) at 20-25° C. following by addition of bis(pinacolato)diboron, B₂(Pin)₂ (16.5 g, 65 mmol), [1,1′-Bis(diphenylphosphino)ferrocene]dichloropalladium(II), Pd(dppf)Cl₂ (111 mg, 0,152 mmol, 3.5 mol %) and potassium acetate, KOAc (11.91 g, 121.32 mmol). Reaction mixture was sparged (subsurface) with argon for 15 minutes and heated to 82-85° C. for 18 hours. The reaction mixture was cooled to 20-25° C., diluted with MeTHF (75 mL) and water (150 mL). Obtained mixture was stirred for 15 minutes, and filtered through Celite. Celite was washed with 15 mL MeTHF and layers were separated. 0.5 M NaOH was added to organic phase and mixture was stirred for 1.5 hours and then filtered through Celite. The phases were separated. Carborn (1.5 g) was added to organic. Mixture was heated to 50-55° C. and stirred for 40 minutes following by fitration through filter paper. Filtrate was evaporated to dryness. Evaporated oil was resolved in MeTHF (20 mL) and EtOH (135 mL) and heated to 35-40° C. 1 M HCl (216.8 mL) was added dropwise to obtained mixture. Reaction mixture was stirred overnight, crystals were filtered off, washed with 2×50 mL EtOH/water (1:1), dried at 40° C./30 mbar yielding 11.9 g pale yellow crystals of benzonitrile, 4-[4-(4,4,5,5-tetramethyl-1,3,2-dioxaborolan-2-yl)-3-formylphenoxy] (Yield: 78.2%).

### Example 1d: Preparation of Crisaborole Form I

Benzonitrile, 4-[4-(4,4,5,5-tetramethyl-1,3,2-dioxaborolan-2-yl)-3-formylphenoxy] (30 g, 85.9 mmol) was dissolved in EtOH (240 mL) under nitrogen. The mixture was cooled to 0-5° C. following by sequential addition of sodium borohydride, NaBH₄ (1,789 g, 47.3 mmol). The reaction mixture was stirred for one hour at 0-5° C. 6 M HCl (90 mL) was added to reaction mixture over 30 minutes. Obtained mixture was heated to 40-45° C. and carbon (3 g) was added following by stirring for 30 minutes. The mixture was filtered through filter paper and paper was washed with 60 mL of hot EtOH. Filtrate was heated to 40-45° C. following by drop wise addition of water over 30 minutes (120 mL). Solution was seeded with 20 mg of 5-(4-cyanophenoxy)-1,3-dihydroxy-1-hydroxy-[2,1]-benzoxaborole (form I). Water (390 ml) was added drop wise over ninety minutes and suspension was gradually cooled down to 20-25° C. Suspension was stirred for two hours, crystals were filtered off, washed with 2×30 mL EtOH/water (1:2) and dried for 3 hours at 40° C./30 mbar yielding 19.28 g off white crystals of 5-(4-cyanophenoxy)-1,3-dihydroxy-1-hydroxy-[2,1]-benzoxaborole (Yield: 89.4%). Crisaborole form I has been confirmed by PXRD.

### Example 2: Preparation of Crisaborole Form II

Crisaborole crude B (150 mg) was dissolved in methanol (10 mL) at RT. Water (25 mL) was added to the solution. The obtained precipitate was filtered. Crisaborole form II has been confirmed by PXRD as presented in FIG. 4.

### Example 3: Preparation of Crisaborole Form III

Crisaborole crude B (500 mg) was dissolved in acetone (4 mL) at RT. Solution (0.175 mL) was put in a crystallization flask and hexane (0.525 mL) was added. The obtained precipitate was filtered. Crisaborole form III has been confirmed by PXRD as presented in FIG. 7.

### Example 4: Preparation of Crisaborole Form IV

Crisaborole crude B (150 mg) was dissolved in methyl acetate (0.5 mL) under heating. The obtained solution was cooled to RT to obtain a solid. Crisaborole form IV has been confirmed by PXRD as presented in FIG. 10.

### Example 5: Preparation of Crisaborole Amorphous

Crisaborole crude B (about 15 mg) was suspended in petroleum ether (6 mL). The suspension was heated to reflux and filtered. The filtrate was left at RT to crystallize. The obtained precipitate was filtered. Crisaborole amorphous has been confirmed by PXRD as presented in FIG. 13.

### Example 6: Crystallization of Crisaborole Form I

Benzonitrile, 4-[4-(4,4,5,5-tetramethyl-1,3,2-dioxaborolan-2-yl)-3-formylphenoxy] (10 g, 28.64 mmol) was dissolved in MeTHF (100 mL) under nitrogen. The mixture was cooled to 0-5° C. following by addition of sodium borohydride, NaBH₄ (0,542 g, 14.32 mmol). EtOH (5.2 mL) was added drop wise keeping the temperature in range 0-5° C. The reaction mixture was stirred for one hour at 0-5° C. 6 M HCl (6 mL) was added drop wise to reaction mixture following by addition of water (90 mL). Layers were separated and carbon (1 g) was added to organic layer. Layer was heated to 40-45° C. for half an hour, filtered through Celite and Celite was washed with 5 mL of MeTHF. Solution was evaporated to dryness and evaporated rest was dissolved in 30 mL of MeTHF. Solution was heated to 45° C. and heptane (60 mL) was added drop wise to the solution. Solution was seeded with ca 10 mg of 5-(4-cyanophenoxy)-1,3-dihydroxy-1-hydroxy-[2,1]-benzoxaborole (form I) and solution was stirred overnight at RI. Suspension was cooled down to 0-5° C. and stirred for 1 hour. Crystals were filtered off, washed with 2×10 mL MeTHF/heptane (1:3) and dried for 3 hours at 40° C./30 mbar yielding 3 g off white crystals of 5-(4-cyanophenoxy)-1,3-dihydroxy-1-hydroxy-[2,1]-benzoxaborole (Yield: 42%). Crisaborole form I has been confirmed by PXRD.

### Example 7: Crystallization of Crisaborole Form I

15 g of 5-(4-cyanophenoxy)-1,3-dihydroxy-1-hydroxy-[2,1]-benzoxaborole (form 1) was dissolved in EtOH tech. (90 mL) under nitrogen and heated to 40-45° C. and filtered through filter paper. Filtrate was heated to 40-45° C. following by drop wise addition of water (30 mL) over 8 minutes. Solution was seeded with ca 10 mg of 5-(4-cyanophenoxy)-1,3-dihydroxy-1-hydroxy-[2,1]-benzoxaborole (form I). Water (60 ml) was added drop wise over 60 minutes and suspension was gradually cooled down to 0-5° C. Suspension was stirred for one hour, crystals were filtered off, washed with 2×30 mL EtOH/water (1:2) and dried for 3 hours at 40° C./30 mbar yielding 13.7 g off white crystals of 5-(4-cyanophenoxy)-1,3-dihydroxy-1-hydroxy-[2,1]-benzoxaborole (Yield: 91.33%). Crisaborole form I has been confirmed by PXRD.

### Example 8: Crystallization of Crisaborole Form I

25.6 g of 5-(4-cyanophenoxy)-1,3-dihydroxy-1-hydroxy-[2,1]-benzoxaborole (form I) was dissolved in EtOH tech. (154 mL) under nitrogen and heated to 40-45° C. Solution was filtered through filter paper and filtrate was heated to 40-45° C. following by drop wise addition of water (51 mL) over 10 minutes. Solution was seeded with ca 120 mg of 5-(4-cyanophenoxy)-1,3-dihydroxy-1-hydroxy-[2,1]-benzoxaborole (form I). Water (102 ml) was added drop wise over 12 minutes and suspension was gradually cooled down to 20-25° C. Suspension was stirred for one hour, crystals were filtered off, washed with 2×30 mL EtOH/water (1:1) and dried for 3 hours at 40° C./30 mbar yielding 24.8 g off white crystals of 5-(4-cyanophenoxy)-1,3-dihydroxy-1-hydroxy-[2,1]-benzoxaborole (Yield: 97%). Crisaborole form I has been confirmed by PXRD.

### Example 9: Crystallization of Crisaborole Form I

2 g of 5-(4-cyanophenoxy)-1,3-dihydroxy-1-hydroxy-[2,1]-benzoxaborole was dissolved in EtOH tech. (8 mL) and MeTHF (2 mL) under nitrogen and heated to 40-45° C. Water (10 mL) was added drop wise over fifteen minutes. Suspension was cooled down to 20-25° C. and stirred for one hour. Crystals were filtered off, washed with 2×5 mL EtOH/water (1:1) and dried for 5 hours at 40° C./30 mbar yielding 1.71 g off white crystals of 5-(4-cyanophenoxy)-1,3-dihydroxy-1-hydroxy-[2,1]-benzoxaborole (Yield: 86%). Crisaborole form I has been confirmed by PXRD.

### Example 10: Crystallization of Crisaborole Form II

5 g of 5-(4-cyanophenoxy)-1,3-dihydroxy-1-hydroxy-[2,1]-benzoxaborole (form I) was dissolved in EtOH tech. (30 mL) under nitrogen and heated to 40-45° C. Solution was filtered through filter paper and water (1) mL) was added drop wise over live minutes. Solution was seeded with 25 mg of 5-(4-cyanophenoxy)-1,3-dihydroxy-1-hydroxy-[2,1]-benzoxaborole (form II) following by drop wise addition of water (20 mL) over twenty three minutes. Suspension was cooled down to 0-5° C. and stirred for one hour. Crystals were filtered off, washed with 2×10 mL EtOH/water (1:1) and dried for 5 hours at 40° C./30 mbar yielding 4.67 g off white crystals of 5-(4-cyanophenoxy)-1,3-dihydroxy-1-hydroxy-[2,1]-benzoxaborole (Yield: 93%). Crisaborole form II has been confirmed by PXRD.

### Example 11: Characterization of Crisaborole Crystalline Form I

### Mechanical Stability

Samples of Crisaborole form I were resistant to mechanical stress of different conditions: pressure of 9 tons on 132.67 mm² for 2 min, strong grinding using mortar and pestle for 2 min and strong grinding with a drop of solvent (e.g. H₂O, EtOH) using mortar and pestle for 2 min. All samples were re-analyzed by PXRD and were found to have been unchanged, showing that form I is stable under these conditions.

### Chemical and Thermodynamic Stability

Samples of Crisaborole form I were stored for 2 weeks at 25° C. 2-8° C., and for 1 month at different stress conditions: 25° C./60% RH, 40° C./75% RH, 50° C. and 50° C./80% RH. All samples were re-analyzed by PXRD and were found to have been unchanged, showing that form I is stable under these conditions. Impurity profile of all samples was also analyzed showing there is no change in impurity profile under these conditions.

### Example 12: Monocrystal Data for Crisaborole Form

Sample of Crisaborole form IV prepared in according to example 4 was used for the calculation of the crystal data.

### Experimental

Rigaku Xcalibur PX system equipped with Onyx CCD detector Cu Kα radiation λ=1.54184 Å,
Enhanced graphite monochromator
Measurement temperature 293 K

### Software

Data reduction: CrysAlisPro, Agilent Technologies, Version 171.31.7
Structure solution: SHELXT (Sheldrick, 2015)
Structure refinement: SHELXL (Sheldrick, 2015)

| Sum formula | C14H10BNO3 |
|---|---|
| Molecular mass (g/mol) | 251.045 |
| Crystal system | Triclinic |
| Space group | P-1 |
| Cell parameters | a = 8.0287(6) Å |
| | b = 9.8654(8) Å |
| | c = 16.2632(12) Å |
| | alpha = 84.067(6)° |
| | beta = 81.453(6)° |
| | gamma = 78.537(6)° |
| Volume of unit cell (Å3) | 1244.81(16) |
| Z (the number of asymmetric units | 4 |
| in the unit cell) | |
| Calculated density (g/mL) | 1.34 |

Further aspects and embodiments of the present invention are set out in the following numbered clauses:

1. A crystalline form III of Crisaborole, which is characterized by data selected from one or more of the following:
(i) a PXRD pattern having peaks at 3.7, 14.8, 16.1, 18.0 and 29.0 degrees 2-theta±0.2 degrees 2-theta;
(ii) a PXRD pattern as depicted in FIG. 7;
or combinations of these data.
2. Crystalline form III of Crisaborole according to Clause 1, which is further characterized by:
(i) a PXRD pattern having peaks at 3.7, 14.8, 16.1, 18.0 and 29.0 degrees 2-theta±0.2 degrees 2-theta, and also having one, two, three, four or five additional peaks at 14.4, 22.8, 25.1, 26.1 and 27.5 degrees 2-theta±0.2 degrees 2-theta;
(ii) a DSC thermogram as depicted in FIG. 8;
(iii) an FTIR spectrum having one, two, three, four or five peaks selected from 2233, 1624, 1282, 972 and 729±4 cm⁻¹;
(iv) an FTIR spectrum as depicted in FIG. 9;
and combinations of these data.
3. Crystalline form IV of Crisaborole, which is characterized by data selected from one or more of the following:
(i) a PXRD pattern having peaks at 5.5, 13.2, 15.7, 18.8 and 19.7 degrees 2-theta±0.2 degrees 2-theta;
(ii) a PXRD pattern as depicted in FIG. 10;
or combinations of these data.
4. Crystalline form IV of Crisaborole according to Clause 3, which is further characterized by:
(i) a PXRD pattern having peaks at 5.5, 13.2, 15.7, 18.8 and 19.7 degrees 2-theta±0.2 degrees 2-theta, and also having one, two, three, four or five additional peaks at 11.9, 16.6, 22.9, 23.9 and 24.5 degrees 2-theta±0.2 degrees 2-theta;
(ii) a DSC thermogram as depicted in FIG. 11;
(iii) an FTIR spectrum having one, two, three or four peaks selected from 2225, 1464, 1128 and 873±4 cm⁻¹;
(iv) an FTIR spectrum as depicted in FIG. 12;
and combinations of these data.
5. An amorphous form of Crisaborole, preferably wherein the amorphous form is characterized by a PXRD pattern as depicted in FIG. 13.
6. A solid state form of Crisaborole according to any of Clauses 1-5, which is polymorphically pure, preferably wherein the solid state form contains: about 20% or less, about 10% or less, about 5% or less, about 2% or less, about 1% or less, or about 0% of any other forms of Crisaborole.
7. Use of a solid state form of Crisaborole according to any of Clauses 1-6, for preparing other solid state forms of Crisaborole.
8. Use of a solid state form of Crisaborole according to any of Clauses 1-6, for the preparation of a pharmaceutical composition or formulation, preferably wherein the pharmaceutical composition or formulation is for treating psoriasis and atopic dermatitis.
9. A solid state form of Crisaborole according to any of Clauses 1-6 for use as a medicament, preferably for the treatment of psoriasis and/or atopic dermatitis.
10. A solid state form of Crisaborole according to any of Clauses 1-6 for use in the preparation of a pharmaceutical composition or formulation, preferably for the treatment of psoriasis and/or atopic dermatitis.
11. A pharmaceutical composition or formulation comprising a solid state form of Crisaborole according to any of Clauses 1-6.
12. A pharmaceutical composition or formulation according to Clause 11 comprising at least one pharmaceutically acceptable excipient, preferably wherein the pharmaceutical composition is for topical treatment, and more preferably wherein the pharmaceutical composition is in a form of cream or ointment.
13. A process for preparing a pharmaceutical composition or formulation according to Clause 12 comprising combining a solid state form of Crisaborole according to any of Clauses 1-6, and at least one pharmaceutically acceptable excipient.
14. A method of treating psoriasis and/or atopic dermatitis, comprising administering a therapeutically effective amount of the solid state form of Crisaborole according to any of Clauses 1-6, or a pharmaceutical composition or formulation according to any of Clauses 11-12 to a subject suffering from psoriasis and/or atopic dermatitis, or otherwise in need of the treatment.
15. A process for preparing other solid state forms of Crisaborole comprising preparing a solid state form of Crisaborole crystalline form I and/or crystalline form II and converting it to another crystalline form of Crisaborole; wherein
(A) crystalline form I is characterized by data selected from one or more of the following:
(i) a PXRD pattern having peaks at 6.0, 14.1, 15.4, 16.1 and 28.5 degrees 2-theta±0.2 degrees 2-theta;
(ii) a PXRD pattern as depicted in FIG. 1;
(iii) a PXRD pattern having peaks at 6.0, 14.1, 15.4, 16.1 and 28.5 degrees 2-theta±0.2 degrees 2-theta, and also having one, two, three, four or five additional peaks at 12.1, 18.2, 21.4, 24.9 and 26.1 degrees 2-theta±0.2 degrees 2-theta;
(iv) a solid state ¹³C NMR spectrum with peaks at 162.4, 155.4, 129.4, 120.9, 119.1±0.2 ppm;
(v) a ¹³C NMR spectrum having the following chemical shift absolute differences from a peak at 117.4 ppm±1 ppm of: 45.0, 38.0, 12.0, 3.5 and 1.7 ppm±0.1 ppm, respectively; or
(vi) a solid state ¹³C NMR spectrum substantially as depicted in FIG. 14;
and combinations of any of (i)-(vi);
and
(B) crystalline form II is characterized by data selected from one or more of the following:
(i) a PXRD pattern having peaks at 7.1, 12.3, 16.7, 21.9 and 23.2 degrees 2-theta±0.2 degrees 2-theta;
(ii) a PXRD pattern as depicted in FIG. 4;
(iii) a PXRD pattern having peaks at 7.1, 12.3, 16.7, 21.9 and 23.2 degrees 2-theta±0.2 degrees 2-theta, and also having one, two, three, four or five additional peaks at 14.3, 16.4, 20.9, 21.5 and 22.6 degrees 2-theta±0.2 degrees 2-theta;
(iv) a solid state ¹³C NMR spectrum with peaks at 161.1, 154.4, 134.4, 124.0 and 122.6±0.2 ppm;
(v) a solid state ¹³C NMR spectrum having the following chemical shift absolute differences from a peak at 115.0±1 ppm of: 46.1, 39.4, 19.4, 9.0 and 7.6 ppm±0.1 ppm, respectively; or
(vi) a solid state ¹³C NMR spectrum substantially as depicted in FIG. 16; and combinations of any of (i)-(vi).

1. A solid state form of Crisaborole selected from:
(A) crystalline form I, which is characterized by data selected from one or more of the following:
(i) a PXRD pattern having peaks at 6.0, 14.1, 15.4, 16.1 and 28.5 degrees 2-theta±0.2 degrees 2-theta;
(ii) a PXRD pattern as depicted in FIG. 1;
(iii) a PXRD pattern having peaks at 6.0, 14.1, 15.4, 16.1 and 28.5 degrees 2-theta±0.2 degrees 2-theta, and also having one, two, three, four or five additional peaks at 12.1, 18.2, 21.4, 24.9 and 26.1 degrees 2-theta±0.2 degrees 2-theta;
(iv) a solid state ¹³C NMR spectrum with peaks at 162.4, 155.4, 129.4, 120.9, 119.1±0.2 ppm;
(v) a ¹³C NMR spectrum having the following chemical shift absolute differences from a peak at 117.4 ppm±1 ppm of: 45.0, 38.0, 12.0, 3.5 and 1.7 ppm±0.1 ppm, respectively; or
(vi) a solid state ¹³C NMR spectrum substantially as depicted in FIG. 14;
and combinations of any of (i)-(vi);
or
(B) crystalline form II, which is characterized by data selected from one or more of the following:
(i) a PXRD pattern having peaks at 7.1, 12.3, 16.7, 21.9 and 23.2 degrees 2-theta±0.2 degrees 2-theta;
(ii) a PXRD pattern as depicted in FIG. 4;
(iii) a PXRD pattern having peaks at 7.1, 12.3, 16.7, 21.9 and 23.2 degrees 2-theta±0.2 degrees 2-theta, and also having one, two, three, four or five additional peaks at 14.3, 16.4, 20.9, 21.5 and 22.6 degrees 2-theta±0.2 degrees 2-theta;
(iv) a solid state ¹³C NMR spectrum with peaks at 161.1, 154.4, 134.4, 124.0 and 122.6±0.2 ppm;
(v) a solid state ¹³C NMR spectrum having the following chemical shift absolute differences from a peak at 115.0±1 ppm of: 46.1, 39.4, 19.4, 9.0 and 7.6 ppm±0.1 ppm, respectively; or
(vi) a solid state ¹³C NMR spectrum substantially as depicted in FIG. 16;
and combinations of any of (i)-(vi).

2. Crystalline form I of Crisaborole according to claim 1, which is characterized by data selected from one or more of the following:
(i) a PXRD pattern having peaks at 6.0, 14.1, 15.4, 16.1 and 28.5 degrees 2-theta±0.2 degrees 2-theta;
(ii) a PXRD pattern as depicted in FIG. 1;
(iii) a PXRD pattern having peaks at 6.0, 14.1, 15.4, 16.1 and 28.5 degrees 2-theta±0.2 degrees 2-theta, and also having one, two, three, four or five additional peaks at 12.1, 18.2, 21.4, 24.9 and 26.1 degrees 2-theta±0.2 degrees 2-theta;
(iv) a solid state ¹³C NMR spectrum with peaks at 162.4, 155.4, 129.4, 120.9, 119.1±0.2 ppm;
(v) a ¹³C NMR spectrum having the following chemical shift absolute differences from a peak at 117.4 ppm±1 ppm of: 45.0, 38.0, 12.0, 3.5 and 1.7 ppm±0.1 ppm, respectively; or
(vi) a solid state ¹³C NMR spectrum substantially as depicted in FIG. 14;
and combinations of any of (i)-(vi).

3. Crystalline form I of Crisaborole according to claim 1, which is characterized by data selected from one or more of the following:
(i) a DSC thermogram as depicted in FIG. 2;
(ii) an FTIR spectrum having one, two, three or four peaks selected from 2225, 1164, 884 and 753±4 cm⁻¹;
(iii) an FTIR spectrum as depicted in FIG. 3;
(iv) a Raman spectrum having peaks at 1605, 1454, 1228, 1165 and 780±4 cm⁻¹; or
(v) a Raman spectrum as depicted in FIG. 15;
and combinations of any of (i)-(v).

4. Crystalline form I of Crisaborole according to claim 1, which is thermodynamically stable after exposure at conditions of up to 50° C. at 80% RH for at least 1 month, or at room temperature/100% RH for at least 7 days as measured by XRPD.

5. Crystalline form II of Crisaborole according to claim 1, which is characterized by data selected from one or more of the following:
(i) a PXRD pattern having peaks at 7.1, 12.3, 16.7, 21.9 and 23.2 degrees 2-theta±0.2 degrees 2-theta;
(ii) a PXRD pattern as depicted in FIG. 4;
(iii) a PXRD pattern having peaks at 7.1, 12.3, 16.7, 21.9 and 23.2 degrees 2-theta±0.2 degrees 2-theta, and also having one, two, three, four or five additional peaks at 14.3, 16.4, 20.9, 21.5 and 22.6 degrees 2-theta±0.2 degrees 2-theta;
(iv) a solid state ¹³C NMR spectrum with peaks at 161.1, 154.4, 134.4, 124.0 and 122.6±0.2 ppm;
(v) a solid state ¹³C NMR spectrum having the following chemical shift absolute differences from a peak at 115.0±1 ppm of: 46.1, 39.4, 19.4, 9.0 and 7.6 ppm±0.1 ppm, respectively; or
(vi) a solid state ¹³C NMR spectrum substantially as depicted in FIG. 16;
and combinations of any of (i)-(vi).

6. Crystalline form II of Crisaborole according to claim 1, which is characterized by data selected from one or more of the following:
(i) a DSC thermogram as depicted in FIG. 5;
(ii) an FTIR spectrum having one, two, three or four peaks selected from 2225, 1370, 1053 and 620±4 cm⁻¹;
(iii) an FTIR spectrum as depicted in FIG. 6;
(iv) a Raman spectrum having peaks at 1614, 1579, 1201, 1078 and 726±4 cm⁻¹; or
(v) a Raman spectrum as depicted in FIG. 17;
and combinations of any of (i)-(v).

7. Crystalline form II of Crisaborole according to claim 1, which is thermodynamically stable after exposure of form II to conditions of up to 50° C./80% RH for at least 1 month, as measured by XRPD.

8. A solid state form of Crisaborole according to claim 1, which is non-hygroscopic.

9. A solid state form of Crisaborole according to claim 1, which is polymorphically pure.

10. A pharmaceutical composition or formulation comprising a solid state form of Crisaborole or combinations thereof according to claim 1.

11. A pharmaceutical composition or formulation according to claim 10 comprising at least one pharmaceutically acceptable excipient.

12. The pharmaceutical composition or formulation according to claim 11 for topical treatment.

13. The pharmaceutical composition or formulation according to claim 11 in a form of a cream or ointment.

14. A process for preparing a pharmaceutical composition or formulation comprising combining a solid state form of Crisaborole according to claim 1 and at least one pharmaceutically acceptable excipient.

15. A method of treating psoriasis and/or atopic dermatitis, comprising administering a therapeutically effective amount of the solid state form of Crisaborole according to claim 1 to a subject suffering from psoriasis and/or atopic dermatitis, or otherwise in need of the treatment, wherein the solid state form of Crisaborole is optionally prepared as a pharmaceutical composition or formulation.
